(19) United States
(12) Patent Application Publication
(10) Pub. No.: US 2025/0368141 A1
(43) Pub. Date: Dec. 4, 2025

(54) Car Seat Net Device

(71) Applicant: Daniel Symons, Jefferson, GA (US)

(72) Inventor: Daniel Symons, Jefferson, GA (US)

(21) Appl. No.: 19/201,149

(22) Filed: May 7, 2025

Related U.S. Application Data
(60) Provisional application No. 63/655,778, filed on Jun. 4, 2024.

(51) Int. Cl. B60R 7/04; B60R 11/00

(52) U.S. Cl. CPC B60R 7/043; B60R 2011/0012; B60R 2011/0063; B60R 2011/0075; B60R 2011/0082

(57) ABSTRACT

A car seat net device is disclosed for easily retrieving dropped items. Traveling with small children in a vehicle may lead to toys and other items being dropped by the children into hard-to-reach areas of the vehicle. The car seat net device secures items around a child sitting in a car seat of a vehicle which eliminates additional stops that may have to be made by the driver to retrieve the dropped items. The car seat net device comprises a net component that is pliable and attached to interchangeable net support arms to accommodate a variety of car seats. The net support arms are attached to the base component which enables the device to be secured to the car seat through an adhesive material or attachment means. Adjusting the net support arms enables the device to be universally applied to all car seats and configured to all vehicles.

### CROSS-REFERENCE TO RELATED APPLICATION

The present application claims priority to, and the benefit of, U.S. Provisional Application No. 63/655,778, which was filed on Jun. 4, 2024, and is incorporated herein by reference in its entirety.

### FIELD OF THE INVENTION

The present invention relates generally to the field of car seat accessories. More specifically, the present invention relates to an improved car seat net device that prevents dropped items from becoming out of reach to children. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in car seat accessory devices. Generally, traveling with children of all ages may lead to toys and other items being dropped into hard-to-reach areas of the vehicle. Further, these dropped items become out of reach and may cause for an unpleasant car ride due to upset children and/or lost items. Drivers need an easier way for their children to access dropped items during their time in a vehicle.

Additionally, this unpleasant time may lead to the driver having to make additional stops to retrieve the dropped items for the children. This could add additional time to long road trips creating more stress and exhaustion for the drivers. Further, it can be difficult to find safe locations for drivers to stop in order to retrieve these items. Without a car seat net device, drivers may need to stop on the side of the highway to retrieve these items, which can be dangerous with other vehicles driving by the vehicle while stationary on the shoulder of the road.

Accordingly, there is a demand for a car seat net device that provides users with a means to secure items around a child sitting in a car seat of a vehicle. More particularly, there is a demand for a car seat net device that is adjustable to meet the needs of a plurality of users and vehicles.

Therefore, there exists a long felt need in the art for a car seat net device that prevents items from being thrown or dropped by a child into and around the areas of a car seat. There is also a long felt need in the art for a car seat net device that comprises a flexible net that provides users with a means to secure items around a child sitting in a car seat of a vehicle. Further, there is a long felt need in the art for a car seat net device that has interchangeable net support arms to meet the appropriate length for a plurality of vehicles. Finally, there is a long felt need in the art for a car seat net device that has a base component comprising an adhesive or hook/loop component that is easily secured to various types of car seats for continuous usage.

The subject matter disclosed and claimed herein, in one embodiment thereof, comprises a car seat net device. The device is designed to prevent toys and other loose items from falling between the car seat, vehicle doors, and other out of reach places after being thrown or dropped by a child within a vehicle. The device is comprised of an adjustable, pivoting net system that attaches to the side of the car seat, ensuring items do not drop into hard-to-reach places within the vehicle. The flexible net is supported by foldable arms of various lengths to fit different car interiors. Further, the base component can be removed and reapplied while the foldable arms collapse for easy transport and storage.

In this manner, the car seat net device of the present invention accomplishes all of the forgoing objectives and provides users with a device that provides a car seat accessory to enable for smoother, more enjoyable road trips. The device can be used with a variety of car seats and vehicles. Additionally, the device can be collapsed for easy storage and transport.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a car seat net device. The device is a car seat net device that easily secures items around a child sitting in a car seat of a vehicle. The car seat net device comprises a net component that includes interchangeable net support arms of various lengths. The net component is secured to the car seat through the base component which can be applied to a variety of car seat types. Finally, the device is secured to the car seat through the adhesive components comprised on the base component. Accordingly, the device enables for traveling with children easier, eliminating additional stops due to dropped items. The device also accounts for easy accessibility for children to retrieve various items while in the car.

In one embodiment, the car seat net device is made up, at a minimum, of the following components: a net component, net support arms, along with a base component comprising an adhesive component to secure the device to the car seat. Optional items may be added to create additional functionality or increase safety, as needed.

In one embodiment, the net component is most often made from an elastic material that conforms to the dropped item. Additionally, the pliable material enables for the net to stretch and adapt to a plurality of widths and lengths of car seats and vehicles. The net component of the device is secured through the net support arms.

In one embodiment, the device comprises several sets of net support arms in various lengths. Moreover, the net support arms can be designed in various lengths (i.e., 3 inches, 5 inches, or 8 inches), to accommodate any type of car configuration. The net support arms pivot when attached to the base component to easily adjust the width of the net and close the net when not in use. The net support arms snap into the ends of the base component that adhere to the car seat.

In one embodiment, the base component is preferably made from a flexible and sturdy material, such as lightweight silicone over molded plastic, to enable the device to conform to any car seat. The base component comprises an adhesive component which secures the device universally to all car seats.

In one embodiment, the adhesive component enables the device to attach to a variety of car seats. The adhesive component is preferably made with high strength double sided tape or any other material known in the art.

In one embodiment, all portions of the present invention are fully enclosed and able to be quickly and easily wiped down and disinfected after accidental spills.

In yet another embodiment, a method of catching dropped items and eliminating the need to make frequent stops to retrieve the dropped items. The method includes the steps of providing a car seat net device comprising a net component, net support arms, and a base component comprising an adhesive component. The method also comprises attaching the appropriate length net support arms to the device. The method also comprises securing the device to the desired car seat using the adhesive component attached to the base component. Further, the method comprising adjusting the net support arms to meet the desired configuration for the vehicle.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the car seat net device attached to a car seat of the present invention in accordance with the disclosed architecture;

FIG. 2 illustrates a perspective view of one embodiment of the car seat net device of the present invention in accordance with the disclosed architecture;

FIG. 3 illustrates a side view of one embodiment of the car seat net device catching a dropped item in accordance with the disclosed architecture of the present invention.

FIG. 4 illustrates an aerial view of one potential embodiment of the car seat net device attached to a car seat of the present invention in accordance with the disclosed architecture;

FIG. 5 illustrates multiple perspective views of one embodiment of the car seat net device demonstrating the use of the device of the present invention in accordance with the disclosed architecture;

FIGS. 6A-C illustrate multiple perspective views of one embodiment of the car seat net device of the present invention showing the device installed including specifics in accordance with the disclosed architecture; and

FIG. 7 illustrates a flowchart showing the method of catching dropped items in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a car seat net device that prevents items from being thrown or dropped by a child into and around the areas of a car seat. Further, there is a long felt need in the art for a car seat net device that enables children to retrieve dropped items preventing the driver from making frequent stops. There is also a long felt need in the art for a car seat net device that comprises a flexible net to provide users with a means to secure items around a child sitting in a car seat of a vehicle. Further, there is a long felt need in the art for a car seat net device that has interchangeable net support arms to meet the appropriate configuration for a plurality of vehicles. Finally, there is a long felt need in the art for a car seat net device that has a base component comprising an adhesive or hook/loop component that is easily secured to various types of car seats for continuous usage.

The present invention, in one exemplary embodiment, is a novel car seat net device. The device is a car seat accessory that easily secures items around a child sitting in a car seat of a vehicle. The car seat net device comprises a net component that includes interchangeable net support arms. The net component is secured to the car seat through the base component which can be applied to a variety of car seat types. Finally, the device is secured to the car seat through the adhesive components comprised on the device base component. Accordingly, the device makes traveling with children easier, eliminating additional stops due to dropped items. The device also accounts for easy accessibility for children of the various items while in the car.

More specifically, the car seat net device is made up, at a minimum, of the following components: a net component, net support arms, along with a base component comprising an adhesive or hook/loop component to secure the device to the car seat. Optional items may be added to create additional functionality or increase safety, as needed.

During use, the net component conforms to the dropped item due to the elastic material that is used to create the net component. Additionally, the pliable material enables for the net to stretch and adapt to a plurality of widths and lengths of car seats and vehicles. The net component of the device is secured through the net support arms.

Further, the device comprises several sets of net support arms in various lengths. Moreover, the net support arms can be designed in various lengths (i.e., from about 3 inches to about 8 inches), to accommodate any type of car configuration. During use, the net support arms pivot to easily adjust the width of the net and close the net when not in use. The net support arms snap into the ends of the base component that adhere to the car seat.

Further, the base component is preferably made from a flexible and sturdy material, such as lightweight silicone over molded plastic, to enable the device to conform to any car seat. The base component comprises an adhesive component which secures the device to the desired car seat. Further, the adhesive component enables the device to attach to a variety of car seats. The adhesive component is preferably made from high strength double sided tape, or any other material known in the art. All portions of the present invention are fully enclosed and able to be quickly and easily wiped down and disinfected after accidental spills.

The present invention is also comprised of a method of using the device. First, a car seat net device is provided comprised of a net component, net support arms, and a base component comprising an adhesive component. Then, the user attaches the appropriate length net support arms to the device. Then, the user secures the device to the desired car seat using the adhesive component attached to the base component. Finally, the user adjusts the net support arms to meet the desired configuration for the vehicle.

Accordingly, the car seat net device of the present invention is particularly advantageous as it provides a device that prevents items from falling into hard-to-reach locations while in a vehicle. More specifically, the car seat net device enables children in car seats to retrieve dropped items. Further, the car seat net device eliminates additional stops for the driver during road trips. Furthermore, the device can be universally applied to any car seat and configured to meet the needs of any vehicle. In this manner, the car seat net device provides a universal solution to dropped items within a vehicle.

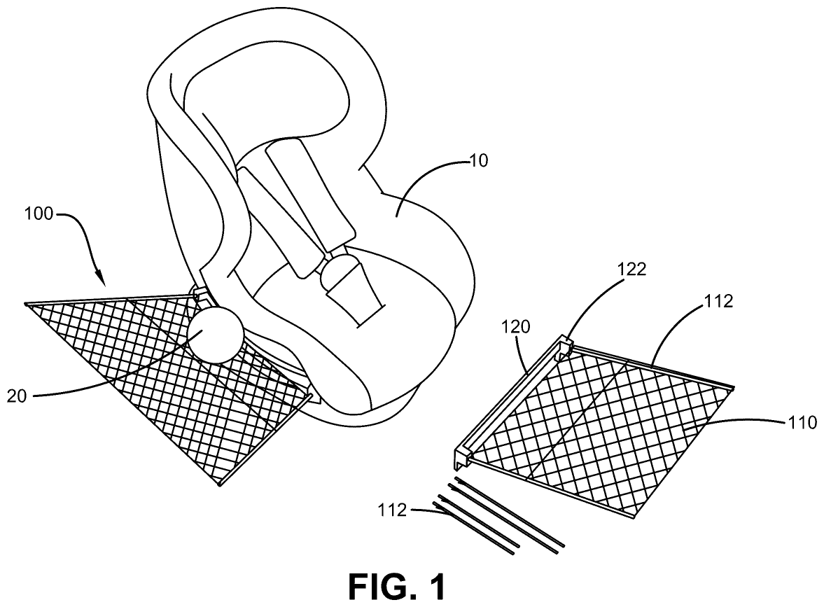

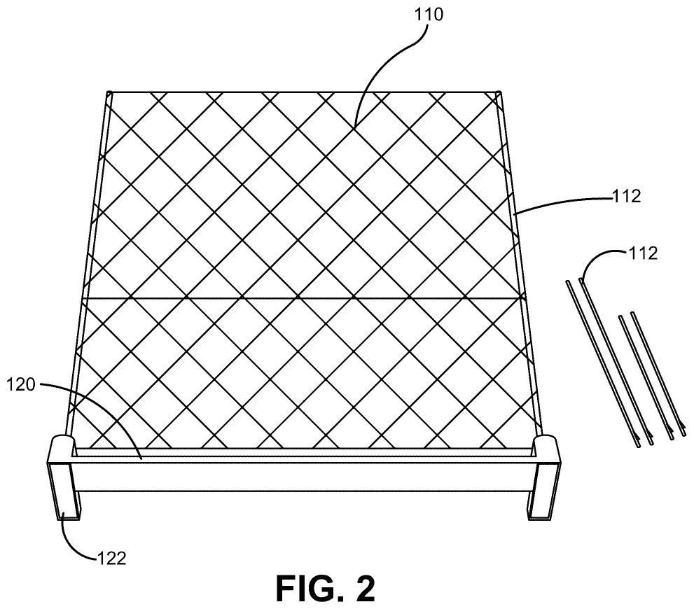

As shown in FIGS. 1-2, the car seat net device 100 comprises a net component 110 that is configured in a rectangular (i.e., rectilinear) shape, but can be any suitable shape and size as is known in the art. The net component 110 is typically an elastic material, but could also be any pliable material that conforms to the dropped item, as is known in the art. The net component 110 is supported through the net support arms 112. The device 100 comprises plurality of net support arms 112 which are various lengths, (i.e., from about 3 inches to about 8 inches), to universally adapt to all vehicles. Further, the net support arms 112 enable for the net component 110 to be easily folded for storage and transport. Further, the appropriate length net support arms 112 are inserted to the base component 120. Thus, the base component 120 enables the net support arms 112 to pivot to enable for the width of the net component 110 to be easily adjusted to fit the configuration of the vehicle. Further, the base component 120 comprises at least one adhesive or attachment component 122 to secure the device 100 to the car seat 10.

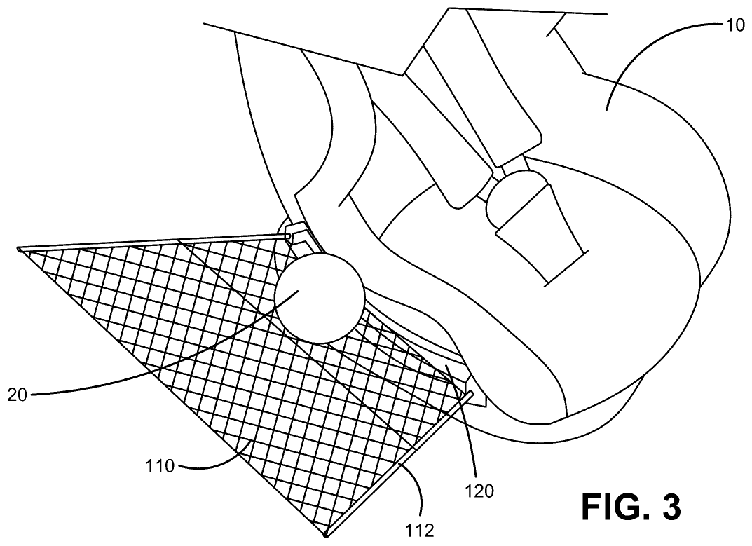

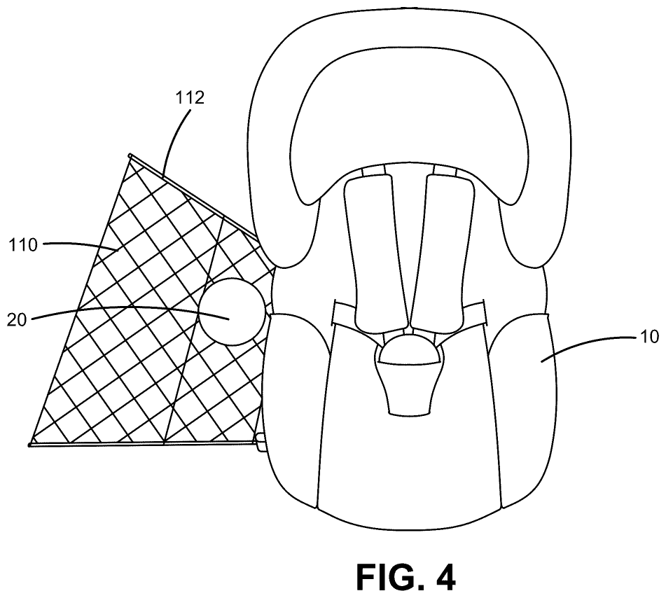

As shown in FIGS. 3-4, the car seat net device 100 secures dropped items 20 within reach for the child. Further, the net component 110 prevents dropped items 20 from falling into hard-to-reach places within the vehicle. Additionally, the net support arms 112 are installed to the base component 120 at an upward angle to prevent the dropped items 20 from falling out of reach. The upward angle of the net component 110 and net support arms 112 enable the dropped items to be easily retrieved by the child, eliminating additional stops for the driver while on a trip.

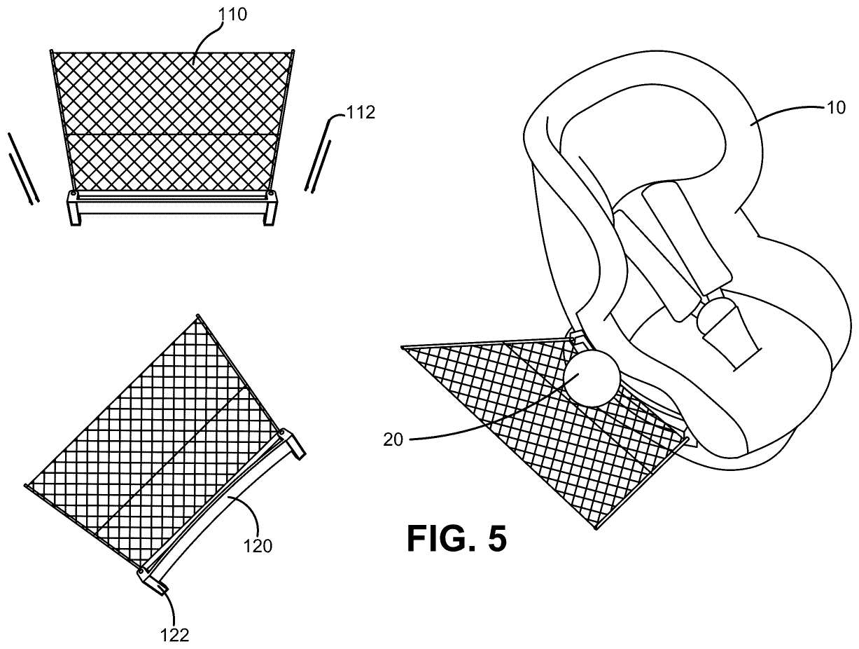

FIG. 5 illustrates multiple perspective views of one embodiment of the car seat net device 100 demonstrating the use of the device 100 of the present invention in accordance with the disclosed architecture. The concept of the car seat net device 100 is designed to be attached to a child's car seat 10 to prevent dropped items 20 from falling in between the car seat 10 and the doors of the vehicle. The device 100 is secured to the car seat 10 with a base component 120 comprising at least one adhesive or attachment component 122.

Further, the adhesive or attachment component 122 is typically high strength double sided tape or any other suitable securing means (i.e., hook and loop) as known in the art. In another embodiment, at least one adhesive or attachment component 122 is made from suction cup technology to enable the device 100 to be attached to a plurality of surfaces. In yet another embodiment, the at least one adhesive component is made from a hook and loop arrangement to enable the device to be attached to a plurality of surfaces.

Additionally, the base component 120 and net support arms 112 are typically made from lightweight silicone over molded plastic to provide safety and durability. Further, all portions of the device 100 are fully enclosed and able to be quickly and easily wiped down and disinfected after accidental spills.

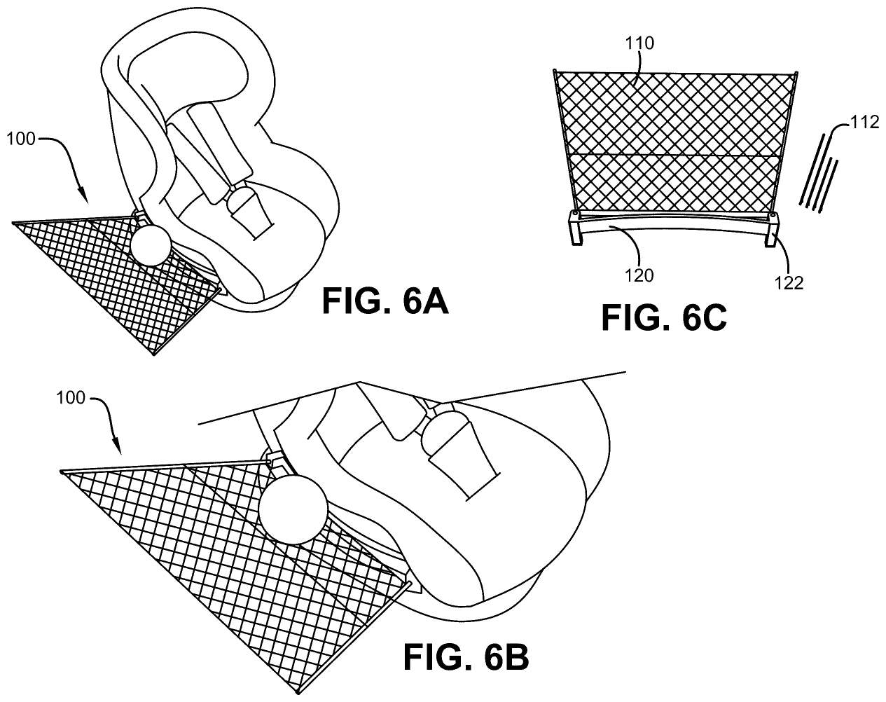

As shown in FIG. 6A-C, the device 100 is comprised of a net component 110 configured with the use of at least one net support arm 112. The flexible net component 110 can catch a plurality of dropped items. Additionally, the folding net support arms 112 come in various sizes to accommodate various gap widths. Furthermore, the net support arms 112 are capable of pivoting while attached to the base component 120 to be universally applied to all vehicles. The base component 120 is secured to the car seat 10 by comprising at least one adhesive or attachment component 122.

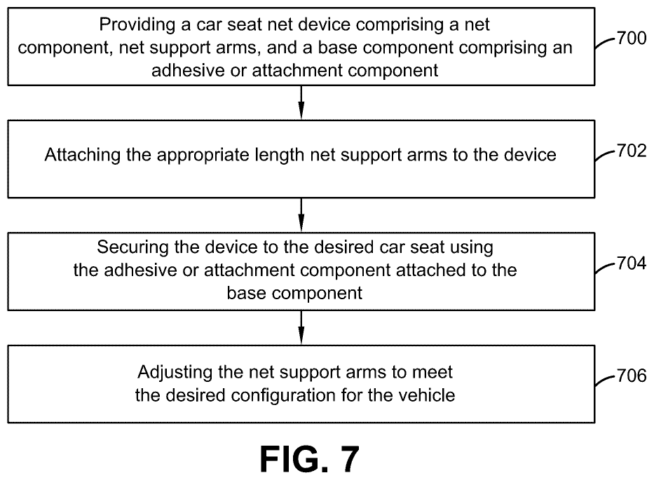

FIG. 7 illustrates a flowchart of the method of catching and securing dropped items 20. The method includes the steps of at 700, providing a car seat net device 100 comprising a net component 110, net support arms 112, and a base component 120 comprising an adhesive or attachment component 122. The method also comprises at 702, attaching the appropriate length net support arms 112 to the device 100. Further, the method comprises at 704, securing the device 100 to the desired car seat 10 using the adhesive or attachment component 122 attached to the base component 120. Finally, the method comprises at 706, adjusting the net support arms 112 to meet the desired configuration for the vehicle.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “car seat net device”, “net device”, “car seat device”, and “device” are interchangeable and refer to the car seat net device 100 of the present invention.

Notwithstanding the forgoing, the car seat net device 100 of the present invention can be of any suitable size and configuration as is known in the art without affecting the overall concept of the invention, provided that it accomplishes the above stated objectives. One of ordinary skill in the art will appreciate that the car seat net device 100 as shown in FIGS. 1-6 is for illustrative purposes only, and that many other sizes and shapes of the car seat net device 100 are well within the scope of the present disclosure. Although the dimensions of the car seat net device 100 are important design parameters for user convenience, the car seat net device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A car seat net device comprising:
a net component;
a base component; and
a plurality of net support arms;
wherein said net component supported between said plurality of net support arms;
wherein said plurality of net support arms include a first selective pair of net support arms having a first matching selectable length;
wherein said plurality of net support arms include a second selective pair of net support arms having a second matching selectable length; and
further wherein said net component is foldable.

2. The car seat net device of claim 1, wherein said plurality of support arms pivotal on said base component for angling said net component upward relative to said base component.

3. The car seat net device of claim 2, wherein said plurality of net support arms include a third selective pair of net support arms having a third matching selectable length.

4. The car seat net device of claim 2, wherein each of said plurality of net support arms having a length from 3 inches to 8 inches.

5. The car seat net device of claim 4, wherein said net component having an adjustable width.

6. The car seat net device of claim 5, wherein said base component having an adhesive component to secure the car seat net device to the car seat.

7. The car seat net device of claim 6, wherein said net component is elastic.

8. The car seat net device of claim 7, wherein said net component having a pliable material;
and further wherein said pliable material conforms to an item dropped into said net component.

9. The car seat net device of claim 8, wherein said net component is rectilinear.

10. A car seat net device comprising:
a net component;
a base component; and
a plurality of net support arms;
wherein said net component supported between said plurality of net support arms;
wherein said plurality of net support arms include a first selective pair of net support arms having a first matching selectable length;
wherein said base component having an adhesive component to secure the car seat net device to the car seat;
further wherein said plurality of support arms pivotal on said base component for angling said net component upward relative to said base component.

11. The car seat net device of claim 10, wherein said plurality of net support arms include a second selective pair of net support arms having a second matching selectable length.

12. The car seat net device of claim 11, wherein said plurality of net support arms include a third selective pair of net support arms having a third matching selectable length.

13. The car seat net device of claim 10, wherein each of said plurality of net support arms having a length from 3 inches to 8 inches.

14. The car seat net device of claim 13, wherein said net component is foldable.

15. The car seat net device of claim 14, wherein said net component having an adjustable width.

16. The car seat net device of claim 15, wherein said net component is elastic.

17. The car seat net device of claim 16, wherein said net component having a pliable material; and further wherein said pliable material conforms to an item dropped into said net component.

18. The car seat net device of claim 17, wherein said net component is rectilinear.

19. A car seat net device comprising:
a net component;
a base component;
a plurality of net support arms; and
an attachment means;
wherein said net component supported between said plurality of net support arms;
wherein said plurality of net support arms include a first selective pair of net support arms having a first matching selectable length;
wherein said base component having said attachment means to secure the car seat net device to the car seat;
wherein said net component is elastic;
wherein said attachment means include suction cups;
further wherein said plurality of support arms pivotal on said base component for angling said net component upward relative to said base component.

20. The car seat net device of claim 19, wherein said net component having a pliable material, and further wherein said pliable material conforms to an item dropped into said net component.
